(19) United States
(12) Patent Application Publication
(10) Pub. No.: US 2026/0011841 A1
(43) Pub. Date: Jan. 8, 2026

(54) SECONDARY BATTERY, ELECTRICALLY DRIVEN APPARATUS INCLUDING SAME, AND METHOD OF MANUFACTURING SAME

(71) Applicant: SAMSUNG SDI CO., LTD., Yongin-Si Gyeonggi-do (KR)

(72) Inventors: Jeawoan LEE, Yongin-Si (KR); Kijun KIM, Yongin-Si (KR); Cheonsoo KIM, Yongin-Si (KR); Won-Seok KIM, Yongin-Si (KR); Soo-Mi EO, Yongin-Si (KR)

(21) Appl. No.: 19/079,137

(22) Filed: Mar. 13, 2025

(30) Foreign Application Priority Data
Jul. 4, 2024 (KR) 10-2024-0088115

(51) Int. Cl. H01M 50/242; H01M 50/202; H01M 50/224; H01M 50/247; H01M 50/262; H01M 50/271

(52) U.S. Cl. CPC H01M 50/242; H01M 50/202; H01M 50/224; H01M 50/247; H01M 50/262; H01M 50/271; H01M 2220/30

(57) ABSTRACT

A secondary battery includes: a case including: a body portion having a receiving space accommodating an electrode assembly; and a flange portion extending horizontally from a top of the body portion, and surrounding around the receiving space; and a cover on the top of the body portion to be bonded to the flange portion and seal the receiving space. The flange portion includes: a first flange protrusion protruding from a first side of the flange portion, and having a first flange hole; and a second flange protrusion protruding from a second side opposite to the first side of the flange portion, and having a second flange hole. The cover includes: a first cover protrusion corresponding to the first flange protrusion, and having a first cover hole; and a second cover protrusion corresponding to the second flange protrusion, and having a second cover hole.

### CROSS-REFERENCE TO RELATED APPLICATION

The present application claims priority to and the benefit of Korean Patent Application No. 10-2024-0088115, filed on Jul. 4, 2024, in the Korean Intellectual Property Office, the entire disclosure of which is incorporated by reference herein.

### BACKGROUND

### 1. Field

Aspects of embodiments of the present disclosure relate to a secondary battery, an electrically driven apparatus including the secondary battery, and a method for manufacturing the secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage.

Aluminum alloys have been used for cases or cans of the secondary batteries in small electronic devices due to their lightweight, formability, and cost-effectiveness. However, such aluminum cans may be damage during various processes. As a result, technology is being researched related to secondary batteries using Steel Use Stainless (SUS) cans, which are formed of stainless steel, as a replacement for aluminum cans.

The above information disclosed in this Background section is for enhancement of understanding of the background of the present disclosure, and therefore, it may contain information that does not constitute related (or prior) art.

### SUMMARY

In the case of the secondary battery having a SUS (stainless steel) can, the secondary battery may be secured to an external device, such as a smartphone, by attaching the secondary battery to an inner surface of the external device using an adhesive tape. However, when the external device is dropped or subjected to an impact, the secondary battery that is secured with the adhesive tape may easily become loose and may shift within the external device. The movement of the secondary battery within a confined space may cause damage to the exterior of the secondary battery, which may lead to leakage, or in more severe cases, may cause short circuits, which can result in smoke or even a fire.

Moreover, with the increasing demand for high-capacity batteries, the size and the weight of the batteries have also increased. As such, the method of securing the battery using the adhesive tape may have limitations in terms of a holding strength, exacerbating the need for more reliable and stable methods and techniques to secure the secondary battery.

One or more embodiments of the present disclosure may be directed to a secondary battery having protrusions at a flange and a cover of a case, and capable of being secured to a housing of an external device through one or more holes formed in each of the protrusions.

One or more embodiments of the present disclosure may be directed to an electrically driven apparatus that includes the secondary battery.

One or more embodiments of the present disclosure may be directed to a method for manufacturing the secondary battery.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to one or more embodiments of the present disclosure, a secondary battery includes: a case including: a body portion having a receiving space accommodating an electrode assembly; and a flange portion extending horizontally from a top of the body portion, and surrounding around the receiving space; and a cover on the top of the body portion to be bonded to the flange portion and seal the receiving space. The flange portion includes: a first flange protrusion protruding from a first side of the flange portion, and having a first flange hole; and a second flange protrusion protruding from a second side opposite to the first side of the flange portion, and having a second flange hole. The cover includes: a first cover protrusion corresponding to the first flange protrusion, and having a first cover hole; and a second cover protrusion corresponding to the second flange protrusion, and having a second cover hole.

In an embodiment, the case and the cover may be configured to be fixed to an external housing by a pair of fastening members, one of the fastening members passing through the first flange hole and the first cover hole, and another of the fastening members passing through the second flange hole and the second cover hole.

In an embodiment, an outer surface of the cover may be adjacent to an inner surface of the external housing, and may contact the inner surface of the external housing by the fastening members.

In an embodiment, the secondary battery may further include a welding line along the flange portion and bonding the cover to the flange portion, and the welding line may have a closed line shape to seal the receiving space.

In an embodiment, the first flange hole, the second flange hole, the first cover hole, and the second cover hole may each be spaced from the welding line by a hole separation distance ranging from 5 mm to 7 mm.

In an embodiment, the first flange protrusion may include one or more first flange protrusions along the first side of the flange portion, and the second flange protrusion may include one or more second flange protrusions along the second side of the flange portion.

In an embodiment, the case and the cover may include the same metallic material as each other.

In an embodiment, the metallic material may include stainless steel.

In an embodiment, the first flange hole may include one or more first flange holes penetrating the first flange protrusion, the second flange hole may include one or more second flange holes penetrating the second flange protrusion, the first cover hole may include one or more first cover holes penetrating the first cover protrusion, and the second cover hole may include one or more second cover holes penetrating the second cover protrusion.

In an embodiment, the case may include an electrode terminal on a side surface of the body portion, the electrode terminal configured to be electrically connected to the electrode assembly.

According to one or more embodiments of the present disclosure, an electrically driven apparatus includes: an operation controller; a housing accommodating the operation controller, and fixing the operation controller in place; and a secondary battery fixed within the housing, and configured to supply power to the operation controller. The secondary battery includes: a case including: a body portion having a receiving space accommodating an electrode assembly; and a flange portion extending horizontally from a top of the body portion and surrounding around the receiving space; and a cover on the top of the body portion to be bonded to the flange portion and seal the receiving space. The flange portion includes: a first flange protrusion protruding from a first side of the flange portion, and having a first flange hole; and a second flange protrusion protruding from a second side opposite to the first side of the flange portion, and having a second flange hole. The cover includes: a first cover protrusion corresponding to the first flange protrusion, and having a first cover hole; and a second cover protrusion corresponding to the second flange protrusion, and having a second cover hole.

In an embodiment, the secondary battery may be configured to be fixed to the housing by a pair of fastening members, one of the fastening members passing through the first flange hole and the first cover hole, and another one of the fastening members passing through the second flange hole and the second cover hole.

In an embodiment, an outer surface of the cover may be adjacent to an inner surface of the housing, and may contact the inner surface of the housing by the fastening members.

In an embodiment, the case and the cover may include the same metallic material as each other.

In an embodiment, the metallic material may include stainless steel.

In an embodiment, the first flange protrusion may include one or more first flange protrusions along the first side of the flange portion, and the second flange protrusion may include one or more second flange protrusions along the second side of the flange portion.

In an embodiment, the operation controller may include one of an application processor (AP) or a central processing unit (CPU) of a portable electronic device, and a motor control unit (MCU) of an electric mobility device.

According to one or more embodiments of the present disclosure, a method for manufacturing a secondary battery, includes: covering a case with a cover, the case including: a body portion having a receiving space accommodating an electrode assembly; and a flange portion extending horizontally from a top of the body portion, and surrounding around the receiving space; bonding the flange portion with the cover to seal the receiving space; forming a first flange protrusion, a second flange protrusion, a first cover protrusion, and a second cover protrusion by cutting the cover bonded to the flange portion; forming a first flange hole and a first cover hole penetrating through the first flange protrusion and the first cover protrusion, respectively; and forming a second flange hole and a second cover hole penetrating through the second flange protrusion and the second cover protrusion, respectively.

In an embodiment, the method may further include fixing the case and the cover to an external housing by a pair of fastening members, one of the fastening members passing through the first flange hole and the first cover hole, and another one of the fastening members passing through the second flange hole and the second cover hole.

In an embodiment, each of the first flange protrusion and the second flange protrusion may include one or more flange protrusions along the flange portion, and each of the first cover protrusion and the second cover protrusion may include one or more cover protrusions along the cover.

According to some embodiments of the present disclosure, by forming protrusions, each containing one or more holes, in the case and the cover, and fixing the secondary battery inside the housing via fastening members, the secondary battery may be stably secured within the housing.

According to some embodiments of the present disclosure, the secondary battery, which has become detached inside the electrically driven apparatus, may be prevented or substantially prevented from colliding inside the electrically driven apparatus, thereby avoiding damage thereto and/or a short-circuiting therein, and enhancing a power stability of the electrically driven apparatus.

However, aspects and features of the present disclosure are not limited to those described above, and other aspects and features not mentioned will be clearly understood by a person skilled in the art from the detailed description, described below

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is an exploded perspective view of a secondary battery according to an embodiment of the present disclosure.

FIG. 2 is a plan view of the secondary battery of FIG. 1.

FIG. 3 is a cross-sectional view of the secondary battery taken along the line a-a′ of FIG. 2.

FIG. 4 is an exploded perspective view of a case and a cover of a secondary battery according to an embodiment of the present disclosure.

FIG. 5 is an exploded perspective view of a case and a cover of a secondary battery according to an embodiment of the present disclosure.

FIG. 6 is a schematic view of an electrically driven apparatus including the secondary battery of FIG. 1 according to an embodiment of the present disclosure.

FIG. 7 is an example of a fixed state of the secondary battery in the electrically driven apparatus of FIG. 6.

FIG. 8 is a cross-sectional view of the electrically driven apparatus taken along the line b-b′ of FIG. 7.

FIG. 9 is a flowchart illustrating a method for manufacturing a secondary battery according to an embodiment of the present disclosure.

FIG. 10 is a flowchart illustrating a method for manufacturing a secondary battery according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are intended to describe embodiments of the present disclosure and are not intended to limit the scope of the present disclosure.

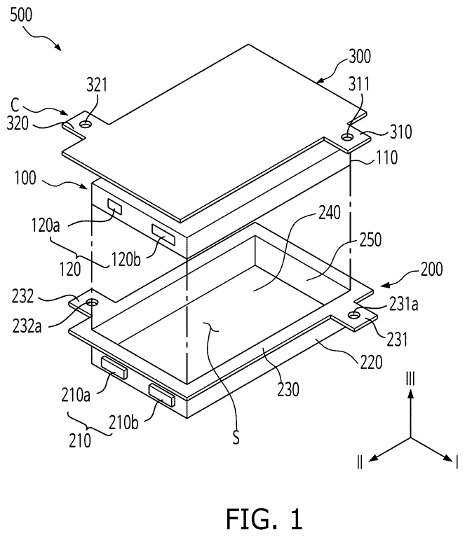

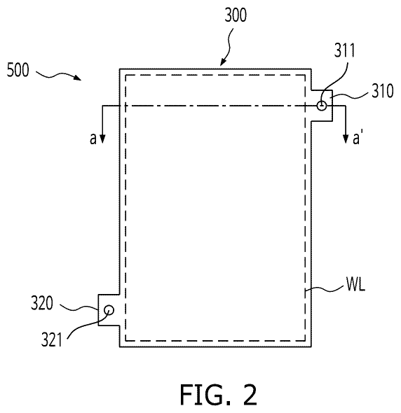

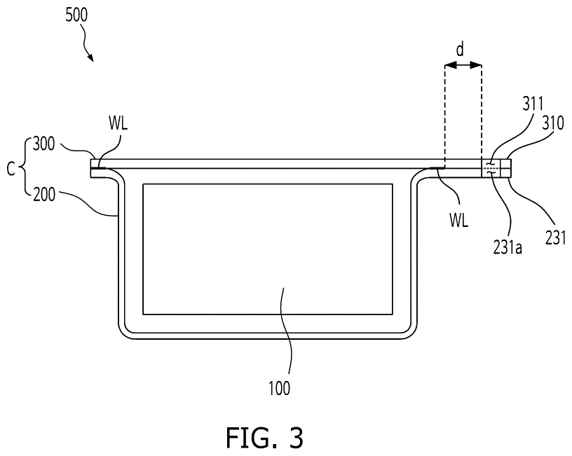

FIG. 1 is an exploded perspective view of a secondary battery according to an embodiment of the present disclosure. FIG. 2 is a plan view of the secondary battery of FIG. 1. FIG. 3 is a cross-sectional view of the secondary battery taken along the line a-a′ of FIG. 2.

Referring to FIGS. 1 to 3, a secondary battery 500 according to an embodiment of the present disclosure may include a case 200, and a cover 300 that covers the case 200. The case 200 may accommodate an electrode assembly 100, and may include a body portion 220 and a flange portion 230.

In an embodiment, the secondary battery 500 may be a Stainless Use Steel (SUS) can secondary battery made of stainless steel, which provides sufficient strength and high resistance to external impacts. However, the present disclosure is not limited thereto, and the secondary battery 500 may be applied to various suitable kinds and/or materials for secondary batteries, as long as the secondary battery 500 may be secured externally by separate fastening means.

In an embodiment, the electrode assembly 100 may store or release energy through a charge transfer between a pair of electrode plates. The electrode assembly 100 may be formed by winding or stacking a laminate 110 including a first electrode plate, a separator, and a second electrode plate, which are respectively formed as thin plates or films. In a case where the electrode assembly 100 is a wound laminate, a winding axis thereof may be parallel to or substantially parallel to a longitudinal direction of the case 200. In other embodiments, the electrode assembly 100 may be a stacking kind instead of being a winding kind, and the shape of the electrode assembly 100 is not particularly limited. For example, the electrode assembly 100 may be a Z-stack electrode assembly in which a separator is folded in a Z-shape, and a positive electrode plate and a negative electrode plate are provided on opposite sides of the separator folded in the Z-shape. In some embodiments, one or more electrode assemblies 100 may be stacked, such that long sides of the electrode assemblies 100 are adjacent to each other and accommodated in the case 200, and the number of electrode assemblies 100 is not particularly limited. The first electrode plate of the electrode assembly 100 may serve as the negative electrode, and the second electrode plate may serve as the positive electrode. However, the present disclosure is not limited thereto, and first electrode plate of the electrode assembly 100 may serve as the positive electrode, and the second electrode plate may serve as the negative electrode.

The first electrode plate may be formed by applying a first electrode active material, such as graphite or carbon, onto a first electrode current collector formed of a metal foil, such as copper, a copper alloy, nickel, or a nickel alloy. The first electrode plate may include a first electrode tab (e.g., a first uncoated portion) 120a, which is a region onto which the first electrode active material is not applied. The first electrode tab 120a may serve as a current flow path between the first electrode plate and a first lead tab. In some embodiments, the first electrode tab 120a may be formed by cutting the first electrode plate in advance during a fabrication process of the first electrode plate, such that the first electrode tab protrudes toward a first side of the electrode assembly, and may extend further out than the separator without requiring an additional cutting.

The second electrode plate may be formed by applying a second electrode active material, such as a transition metal oxide, onto a second electrode current collector formed of a metal foil, such as aluminum or an aluminum alloy. The second electrode plate may include a second electrode tab (e.g., a second uncoated portion) 120b, which is a region onto which the second electrode active material is not applied. The second electrode tab 120b may serve as a current flow path between the second electrode plate and a second lead tab. In some embodiments, the second electrode tab 120b may be formed by cutting the second electrode plate in advance during a fabrication process of the second electrode plate, such that the second electrode tab 120b protrudes toward a second side (e.g., the opposite side of the first side), and may extend further than the separator without requiring an additional cutting.

The first electrode tab 120a and the second electrode tab 120b may be welded to the first lead tab and the second lead tab, respectively. The lead tabs are then electrically connected to a first electrode terminal 210a and a second electrode terminal 210b, which are provided on the body portion 220 of the case 200.

The case 200 may include the electrode terminals 210 disposed on a side surface of the body portion 220 to be electrically connected to the electrode assembly 100. The electrode terminals 210 may include the first electrode terminal 210a and the second electrode terminal 210b. On the side surface of the body portion 220 of the case 200, the first electrode terminal 210a and the second electrode terminal 210b are provided to connect with the first electrode tab 120a and the second electrode tab 120b, respectively, allowing the electrode assembly 100 to be connected to an external power source or a load.

In an embodiment, the secondary battery 500 may include a lithium battery cell, a sodium battery cell, or the like. However, the present disclosure is not limited thereto, and the secondary batter 100 may include various suitable kinds of batteries capable of repeatedly providing electricity through charging and discharging cycles. For example, the electrode assembly 100 may be accommodated in a can C made of stainless use steel (SUS), which is composed of the case 200 and the cover 300, allowing the secondary battery 500 to be provided as a SUS can-type of battery.

The case 200 may include the body portion 220, in which a receiving space S for accommodating the electrode assembly 100 is formed, and the flange portion 230 extending horizontally from upper edges of the body portion 220 to surround (e.g., around a periphery of) the receiving space S.

The body portion 220 may include a bottom 240, and four sidewalls 250 extending vertically from the bottom 240, such that the receiving space S of the body portion 220 may be defined by the bottom 240 and the four sidewalls 250. For example, the four sidewalls 250 may include two long sides that are opposite to each other, and two short sides that are opposite to each other, such that the case 200 is provided in a box shape having an open top. Accordingly, the electrode assembly 100 may be disposed inside the case 200 to be supported by the bottom 240 and enclosed by the four sidewalls 250.

In an embodiment, the first electrode tab 120a and the second electrode tab 120b of the electrode assembly 100 accommodated in the case 200 may be arranged to face the same sidewall 250 of the body portion 220 as each other, and the first electrode terminal 210a and the second electrode terminal 210b may be disposed adjacent to each other on the corresponding sidewall 250.

In another embodiment, the first and second electrode tabs 120a and 120b may be symmetrically arranged to respectively face two of the sidewalls 250 that are opposite to each other. Further, the first and second electrode terminals 210a and 210b may be symmetrically and respectively disposed on the corresponding two sidewalls 250 that are opposite to each other.

In the present embodiment, the sidewalls 250 may have a height of approximately 3 mm to 10 mm from the bottom 240. However, the present disclosure is not limited thereto, and the height may be variously adjusted as needed or desired based on the characteristics of the can C including the electrode assembly 100, the case 200, and the cover 300.

The flange portion 230 may be formed to extend along a horizontal direction from the upper edges of the body portion 220, surrounding (e.g., around a periphery of) the receiving space S. In an embodiment, the flange portion 230 may include a flat or substantially flat plate extending by a suitable width (e.g., a predetermined width) in a first direction I and a second direction II along a periphery of the body portion 220. Further, the flange portion 230 may be formed of a material that is the same or substantially the same as that of the body portion 220.

In an embodiment, the flange portion 230 may be extended from the sidewalls 250 to have a sufficient length to form a first flange protrusion 231 and a second flange protrusion 232, which will be described in more detail below. For example, the flange portion 230 may extend from the sidewalls 250 in a range of approximately 10 mm to 15 mm.

The flange portion 230 may include the first flange protrusion 231 protruding from a first side of the flange portion 230, and the second flange protrusion 232 protruding from a second side opposite to the first side of the flange portion 230. The first flange protrusion 231 may be formed with a first flange hole 231a, and the second flange protrusion 232 may be formed with a second flange hole 232a.

For example, as illustrated in FIG. 1, the first flange protrusion 231 may be formed adjacent to one end of the first side of the flange portion 230 in the second direction II, and the second flange protrusion 232 may be formed adjacent to the other end of the second side of the flange portion 230 in the second direction II. As such, the formation of minimal protrusions may be facilitated, thereby enabling a stable fixation of the entire area of the secondary battery to an external housing.

The first flange hole 231a may be formed through the first flange protrusion 231. The second flange hole 232a may be formed through the second flange protrusion 232. In an embodiment, the first flange hole 231a may be formed through the center of the first flange protrusion 231, and the second flange hole 232a may be formed through the center of the second flange protrusion 232. In the present embodiment, the case 200 may be formed of a metallic material, such as stainless steel (e.g., Stainless Use Steel (SUS)) or aluminum (Al). However, the present disclosure is not limited thereto, and the case may be formed of various suitable metallic materials, as long as the case has sufficient strength and resistance to external impacts as desired for the secondary battery 500.

The cover 300 may include a flat or substantially flat plate that is disposed on a top of the case 200 to seal the receiving space S. For example, the cover 300 may be provided as a flat or substantially flat plate suitably sized to cover both the body portion 220 and the flange portion 230, so as to make surface contact with the flange portion 230. A bottom surface of the cover 300 may be arranged to make surface contact with a top surface of the flange portion 230.

Upon achieving surface contact between the flange portion 230 and the cover 300, the cover 300 may be bonded to the flange portion 230 along its length. In an embodiment, the cover 300 may be welded to the flange portion 230 to form a welding line WL, which may be a closed line, to seal the receiving space S. For example, a laser welding may be performed along the flange portion 230 from the top of the cover 300, thereby securely bonding the cover 300 to the flange portion 230. In the present embodiment, the bonding process may be performed using the laser welding, but the present disclosure is not limited thereto, and various suitable bonding methods may be employed to effectively seal the electrode assembly. For example, the cover 300 and the flange portion 230 may be bonded through various suitable methods from among welding, brazing, or soldering, as well as the laser welding described above.

In an embodiment, the cover 300 may be made of the same metallic material as that of the case 200. In this case, the metallic material may include stainless steel. However, the present disclosure is not limited thereto, and similar to the case 200, the cover 300 may be formed from either stainless steel (SUS) or aluminum (Al), or any other suitable material having sufficient strength and resistance to external impacts.

In a case where the flange portion 230 and the cover 300 are positioned to have surface contact and then bonded to each other, the flange portion 230 and the cover 300, which are made of the same material as each other, may be welded to each other to form the welding line WL. The welding line WL may be formed at a suitable distance (e.g., a predetermined distance) from the sidewalls 250.

The welding line WL may be formed to surround (e.g., around a periphery of) the receiving space S, effectively preventing external moisture from reaching the electrode assembly 100 that is accommodated in the receiving space S. Accordingly, the operational stability of the electrode assembly 100 may be improved.

In an embodiment, the welding line WL may be positioned in close proximity to the sidewalls 250 to effectively block the supply of moisture. For example, the welding line WL may be formed and positioned at a distance of approximately 3 mm to 7 mm from the edge of the sidewalls 250.

The cover 300 may include a first cover protrusion 310 and a second cover protrusion 320. The first cover protrusion 310 may be formed at a position corresponding to the first flange protrusion 231. Further, the second cover protrusion 320 may be formed at a position corresponding to the second flange protrusion 232.

The cover 300 may include the first cover protrusion 310 protruding from a first side of the cover 300, and the second cover protrusion 320 protruding from a second side opposite to the first side of the cover 300. The first cover protrusion 310 may be formed with a first cover hole 311, and the second cover protrusion 320 may be formed with a second cover hole 321.

For example, as illustrated in FIG. 1, the first cover protrusion 310 may be formed adjacent to one end of the first side of the cover 300 in the second direction II, and the second cover protrusion 320 may be formed adjacent to the other end of the second side of the cover 300 in the second direction II. As such, the formation of minimal protrusions may be facilitated, thereby enabling a stable fixation of the entire area of the secondary battery to the external housing.

The first cover hole 311 may be formed through the first cover protrusion 310. The second cover hole 321 may be formed through the second cover protrusion 320. In an embodiment, the first cover hole 311 may be formed through the center of the first cover protrusion 310, and the second cover hole 321 may be formed through the center of the second cover protrusion 320.

The first flange hole 231a, the second flange hole 232a, the first cover hole 311, and the second cover hole 321 may be formed to be spaced apart from the welding line WL by a hole separation distance d. For example, the hole separation distance d may range from 5 mm to 7 mm. As illustrated in FIG. 3, the first flange hole 231a and the first cover hole 311 may be formed to have the same or substantially the same size as each other. Similarly, the second flange hole 232a and the second cover hole 321 may be formed to have the same or substantially the same size as each other. In an embodiment, the case 200 and the cover 300 may be made of stainless steel, providing a sufficient strength. As a result, the electrode assembly 100 may be reliably protected even from strong external impacts. Furthermore, the first flange protrusion 231, the first cover protrusion 310, the second flange protrusion 232, and the second cover protrusion 320 may be made of stainless steel to improve a fastening strength when securing the secondary battery 500 to an external apparatus.

Accordingly, the secondary battery 500 may be securely fixed to the external housing, thereby preventing or substantially preventing impacts or short circuits that may be caused by a movement of the secondary battery 500.

The first flange protrusion 231, the first cover protrusion 310, the second flange protrusion 232, and the second cover protrusion 320 may be provided in various suitable shapes. The first flange protrusion 231, the first cover protrusion 310, the second flange protrusion 232, and the second cover protrusion 320 may prevent or substantially prevent damage to the electrode assembly 100, and may allow for a stable welding.

In an embodiment, the first flange protrusion 231, the first cover protrusion 310, the second flange protrusion 232, and the second cover protrusion 320 may have a rectangular shape. However, the present disclosure is not limited thereto, and they may have various suitable shapes, such as a circular shape, a polygonal shape, or the like.

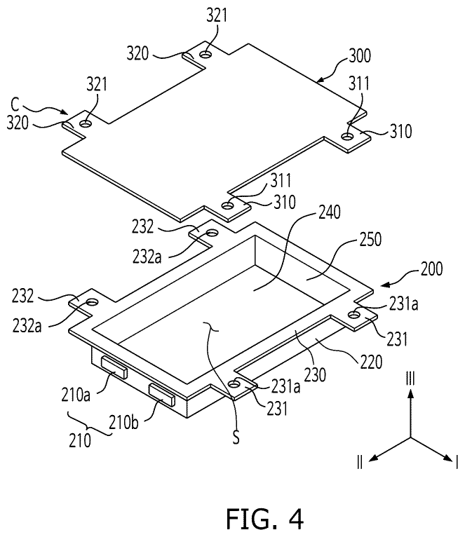

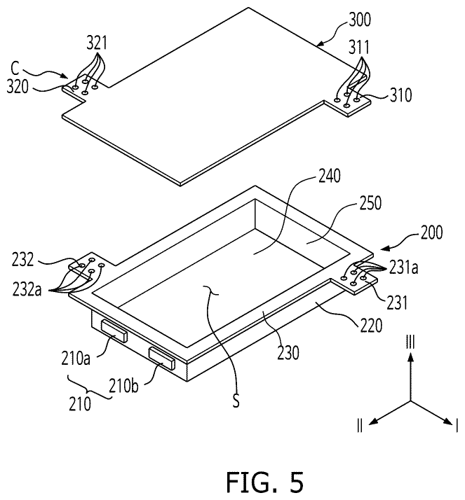

FIG. 4 is an exploded perspective view of a case and a cover of a secondary battery according to an embodiment of the present disclosure. FIG. 5 is an exploded perspective view of a case and a cover of a secondary battery according to an embodiment of the present disclosure.

In an embodiment, one or more first flange protrusions 231 and one or more second flange protrusions 232 may be formed. For example, as illustrated in FIG. 4, two first flange protrusions 231 and two second flange protrusions 232 may be formed. A pair of first flange protrusions 231 may be spaced apart from each other, and may be formed adjacent to opposite ends along a first side of the flange portion 230, respectively. Similarly, a pair of second flange protrusions 232 may be spaced apart from each other, and may be formed adjacent to opposite ends along a second side, which is opposite to the first side, of the flange portion 230, respectively.

The first cover protrusion 310 and the second cover protrusion 320 may be formed at positions corresponding to the first flange protrusion 231 and the second flange protrusion 232, respectively. Therefore, one or more first cover protrusions 310 and one or more second cover protrusions 320 may be formed. For example, as illustrated in FIG. 4, two first cover protrusions 310 and two second cover protrusions 320 may be formed. A pair of first cover protrusions 310 may be spaced apart from each other, and may be formed adjacent to opposite ends along a first side of the cover 300, respectively. Similarly, a pair of second cover protrusions 320 may be spaced apart from each other, and may be formed adjacent to opposite ends along a second side, which is opposite to the first side, of the cover 300, respectively.

By forming the protrusions that are adjacent to the four corners of the secondary battery, respectively, the entire area of the secondary battery may be stably fixed to the external housing.

In another embodiment, referring to FIG. 5, one or more first flange holes 231a, one or more second flange holes 232a, one or more first cover holes 311, and one or more second cover holes 321 may be formed. For example, the single first flange protrusion 231 may be formed to have four first flange holes 231a. The single first cover protrusion 310 may be formed to have four first cover holes 311. The single second flange protrusion 232 may be formed to have four second flange holes 232a. The single second cover protrusion 320 may be formed to have four second cover holes 321.

For example, the four first flange holes 231a may be positioned adjacent to the four corners of the rectangular-shaped first flange protrusion 231. As such, the fixing force of the first flange protrusion 231 when secured to the external housing may be enhanced.

Each of the one or more first flange holes 231a, the one or more second flange holes 232a, the one or more first cover holes 311, and the one or more second cover holes 321 may have a fastening member, such as a bolt, inserted thereinto to improve the fixing force of the secondary battery to the external housing.

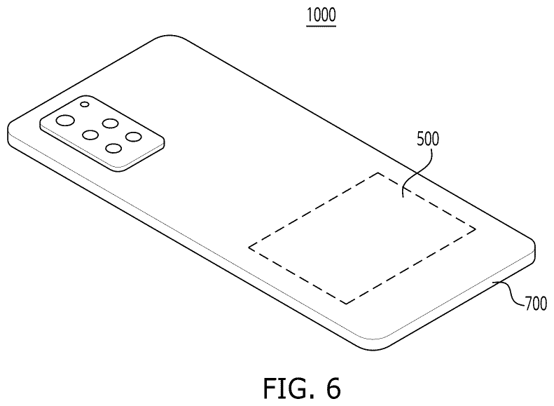

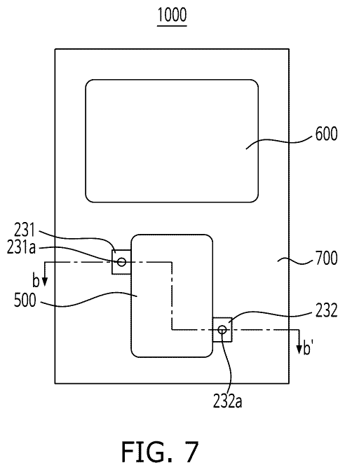

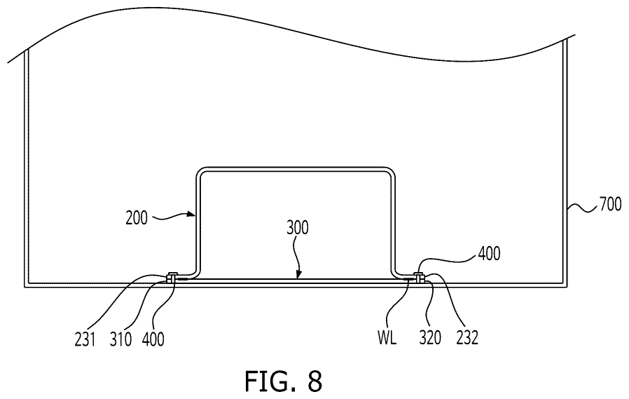

FIG. 6 is a schematic view of an electrically driven apparatus including the secondary battery of FIG. 1 according to an embodiment of the present disclosure. FIG. 7 is an example of a fixed state of the secondary battery in the electrically driven apparatus of FIG. 6. FIG. 8 is a cross-sectional view of the electrically driven apparatus taken along the line b-b′ of FIG. 7.

In an embodiment, the secondary battery 500 may be fixed to a smartphone illustrated in FIG. 7 as a representative example of the electrically driven apparatus, but the present disclosure is not limited thereto, and the electrically driven apparatus may include or may be implemented as various suitable electronic apparatuses that utilize the electric energy stored in the secondary battery 500 as a power source.

Referring to FIGS. 6 and 7, an electrically driven apparatus 1000 according to an embodiment of the present disclosure may include an operation unit (e.g., an operation controller) 600 that performs an operation (e.g., a predetermined operation), a housing 700 that accommodates the operation unit 600 therein, and a secondary battery 500 that is fixed within the housing 700 to supply power to the operation unit 600.

The operation unit 600 may include various suitable operational components that are driven by electric energy upon receiving power. For example, the operation unit 600 may include an application processor (AP) and/or a central processing unit (CPU) of a portable electronic device, and a motor control unit (MCU) of an electric mobility device.

For example, a printed circuit board provided with signal transmission wirings may be arranged in the housing 700, and the operation unit 600 may be mounted on the printed circuit board to be electrically connected to the other components of the electrically driven apparatus 1000.

The housing 700 may accommodate the operation unit 600 and the secondary battery 500 therein, and may form the overall outer appearance of the electrically driven apparatus 1000. The housing 700 may include various suitable structural configurations and components to support the operation unit 600 and the secondary battery 500 disposed therein, and may protect them from external impacts.

The secondary battery 500 may be securely mounted within the housing 700, and may provide stable power to the operation unit 600. In an embodiment, the secondary battery 500 may have a configuration that is the same or substantially the same as that of the secondary battery 500 described above with reference to FIGS. 1 to 3. Therefore, in FIGS. 6 to 8, like reference numerals and symbols are used to denote the same or substantially the same parts as those described above with reference to FIGS. 1 to 3, and thus, redundant description may not be repeated.

For example, the secondary battery 500 may be disposed in a power supply area inside the housing 700, and may be connected to power terminals of the printed circuit board. Accordingly, the electrical energy stored in the secondary battery 500 may be used to drive the operation unit 600.

In more detail, the secondary battery 500 may be provided as a SUS can-kind of battery in which the electrode assembly 100 is arranged within a SUS can C made of stainless steel.

The case 200 and the cover 300 of the secondary battery 500 may be fixed to the external housing 700 by a pair of fastening members 400 that pass through the first flange hole 231a and the first cover hole 311, as well as the second flange hole 232a and the second cover hole 321. The cover 300 is arranged so that an outer surface of the cover 300 is adjacent to an inner surface of the housing 700 and comes into contact with the inner surface of the housing 700 by the fastening members 400. For example, the case 200 and the cover 300 may be fixed to the external housing 700 by inserting the fastening members 400 into the hole(s) formed in each of the case 200 and the cover 300, while they are in a mutually coupled state.

As illustrated in FIG. 8, in a case where the outer surface of the cover 300 is positioned adjacent to the inner surface of the housing 700, the fastening member 400 may be inserted into the first flange hole 231a and subsequently into the first cover hole 311, thereby securing the secondary battery 500 to the housing 700. Similarly, the fastening member 400 may be inserted into the second flange hole 232a and subsequently into the second cover hole 321, thereby securing the secondary battery 500 to the housing 700. The fastening members 400 may be fastened to the housing 700 while passing through the holes. The fastening members 400 may, for example, include or be bolts, and grooves capable of receiving the bolts may be formed in the housing 700.

For example, by using a cutting device such as a laser cutter, the first flange hole 231a, the second flange hole 232a, the first cover hole 311, and the second cover hole 321 may be formed by penetrating through portions of the first flange protrusion 231, the second flange protrusion 232, the first cover protrusion 310, and the second cover protrusion 320. In this case, the first flange hole 231a, the second flange hole 232a, the first cover hole 311, and the second cover hole 321 may be formed to conform to the characteristics and sizes of the fastening members 400, which may include, for example, screws or bolts used to secure the secondary battery 500, by precisely controlling the operation of the laser cutter.

The first flange hole 231a, the second flange hole 232a, the first cover hole 311, and the second cover hole 321 may be arranged to maintain a suitable hole separation distance (e.g., a predetermined hole separation distance) d from the welding line WL to prevent moisture entering the first flange hole 231a, the second flange hole 232a, the first cover hole 311, and the second cover hole 321 from being introduced to the electrode assembly 100. For example, the hole separation distance d between the welding line WL and each of the first flange hole 231a, the second flange hole 232a, the first cover hole 311, and the second cover hole 321 may be in a range of about 5 mm to 7 mm.

Additionally, the inner surfaces of the first flange hole 231a, the second flange hole 232a, the first cover hole 311, and the second cover hole 321 may be coated with an insulating material to electrically isolate the fastening members 400 inserted into the first flange hole 231a, the second flange hole 232a, the first cover hole 311, and the second cover hole 321 from the case 200 and the cover 300. As a result, the secondary battery 500 may be prevented from being short-circuited by the fastening members 400.

In an embodiment, the secondary battery 500 may be detachably fixed to the housing 700 by the fastening members 400. Accordingly, the secondary battery 500 may be replaced from the electrically driven apparatus 1000 as necessary or desired. Further, while the bolts are described as a representative example of the fastening members 400, various suitable coupling elements may be used to detachably fix the secondary battery 500 to the housing 700.

According to the electrically driven apparatus 1000 as described above, the secondary battery 500, which supplies power to the operation unit 600, may be secured inside the housing 700 by the fastening members 400. Therefore, even when the weight of the secondary battery 500 increases due to an increase in a capacity thereof, the secondary battery 500 may remain stably fixed to the housing 700, preventing damage to the secondary battery 500 or short-circuit defects that may be caused by the detachment of the secondary battery 500 within the electrically driven apparatus 1000.

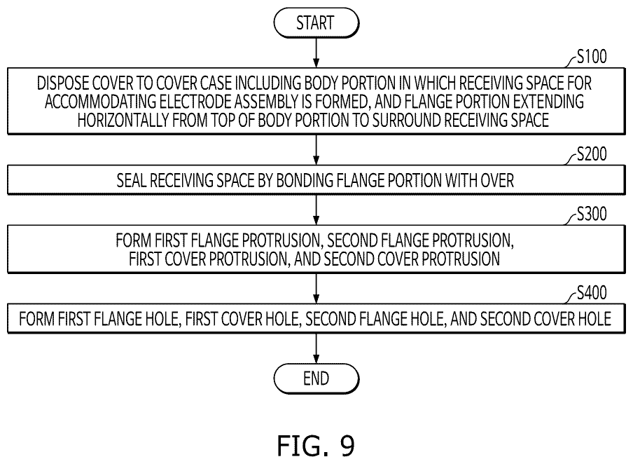

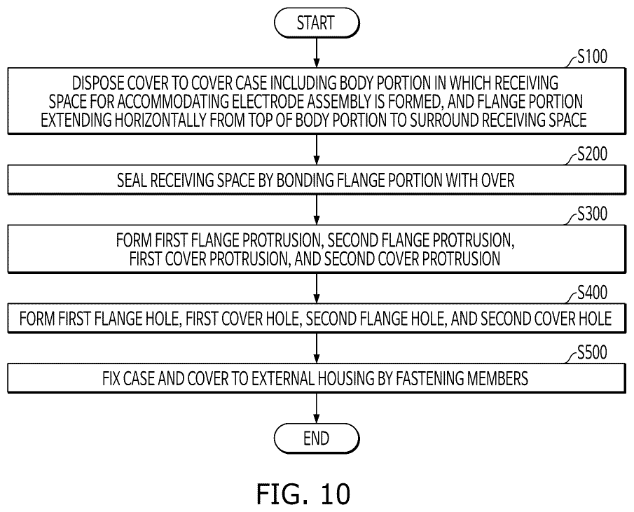

FIG. 9 is a flowchart illustrating a method for manufacturing a secondary battery according to an embodiment of the present disclosure. FIG. 10 is a flowchart illustrating a method for manufacturing a secondary battery according to an embodiment of the present disclosure. For example, FIG. 10 may further include a process for fixing the case and the cover to an external housing by fastening members (S500) in a method for manufacturing a secondary battery according to an embodiment of the present disclosure.

Referring to FIGS. 9 and 10, a method for manufacturing a secondary battery according to an embodiment of the present disclosure may include disposing the cover 300 to cover the case 200 that includes the body portion 220 and the flange portion 230 (S100); sealing the receiving space S by bonding the flange portion 230 with the cover 300 (S200); cutting the cover 300 bonded to the flange portion 230 to form the first flange protrusion 231, the second flange protrusion 232, the first cover protrusion 310, and the second cover protrusion 320 (S300); and forming the first flange hole 231a, the first cover hole 311, the second flange hole 232a, and the second cover hole 321 (S400).

In an embodiment, the disposing of the cover 300 (S100) may include placing the cover 300 on the top of the case 200, in which the electrode assembly 100 is accommodated. The cover 300 may be placed to cover the case 200, which includes the body portion 220 that forms the receiving space S for the electrode assembly 100, and the flange portion 230 that extends horizontally from the top of the body portion 220 to surround (e.g., around a periphery of) the receiving space S.

The electrode assembly 100 manufactured through an assembly process may be transported by a transport device, and may be accommodated within the receiving space S of the body portion 220 having the flange portion 230 at the top.

After the disposing of the cover 300 (S100), the sealing of the receiving space S by bonding the flange portion 230 and the cover 300 may be performed (S200). In the sealing of the receiving space S (S200), the cover 300 may be placed to cover both the receiving space S and the flange portion 230 to be close contact with each other, and a laser welding may be performed along the flange portion 230 from the top of the cover 300 to bond the flange portion 230 and the cover 300 to each other. The resulting welding line WL may be formed to surround (e.g., around a periphery of) the receiving space S, so that moisture, which may enter the electrode assembly 100 disposed in the receiving space S from the external environment, may be effectively blocked.

After the sealing of the receiving space S (S200), the cutting of the cover 300, which is bonded to the flange portion 230, to form the first flange protrusion 231, the second flange protrusion 232, the first cover protrusion 310, and the second cover protrusion 320 may be performed (S300). The forming of the first flange protrusion 231, the second flange protrusion 232, the first cover protrusion 310, and the second cover protrusion 320 may be performed by cutting the cover 300, which is bonded to the flange 230, while leaving some portions of the cover uncut. For example, the forming of the first flange protrusion 231, the second flange protrusion 232, the first cover protrusion 310, and the second cover protrusion 320 may be performed by using a cutting device, such as a laser cutter, to cut the cover 300 that is bonded to the flange 230, excluding the portions of the first flange protrusion 231, the second flange protrusion 232, the first cover protrusion 310, and the second cover protrusion 320 while the cutting may be performed adjacent to the welding line WL. For each of the first flange protrusion 231, the second flange protrusion 232, the first cover protrusion 310, and the second cover protrusion 320, one or more protrusions may be formed.

Subsequently, the forming of the first flange hole 231a and the first cover hole 311, and forming of the second flange hole 232a and second cover hole 321 may be performed (S400). The first flange hole 231a and the first cover hole 311 may be formed by penetrating through the first flange protrusion 231 and the first cover protrusion 310. The second flange hole 232a and the second cover hole 321 may be formed by penetrating through the second flange protrusion 232 and the second cover protrusion 320.

For example, the through-holes may be easily formed by concentrating a running time of the laser cutter on the area for forming the first flange hole 231a and the first cover hole 311, and the area for forming the second flange hole 232a and the second cover hole 321.

For example, the first flange hole 231a and the first cover hole 311 may be formed, and the second flange hole 232a and the second cover hole 321 may be formed with a hole separation distance d ranging from approximately 5 mm to 7 mm from the welding line WL.

The method for manufacturing the secondary battery according to an embodiment of the present disclosure may further include fixing the case 200 and the cover 300 to the external housing 700 (S500). The fixing may be carried out by having a pair of fastening members 400 pass through the first flange hole 231a and the first cover hole 311, as well as through the second flange hole 232a and the second cover hole 321, thereby fixing the case 200 and the cover 300 to the external housing 700.

Accordingly, it may be possible to prevent or substantially prevent damage to the secondary battery and/or short-circuit defects that may be caused by a collision of a detached secondary battery within the electrically driven apparatus, and thus, power stability of the electrically driven apparatus may be enhanced.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
a case comprising:
a body portion having a receiving space accommodating an electrode assembly; and
a flange portion extending horizontally from a top of the body portion, and surrounding around the receiving space; and
a cover on the top of the body portion to be bonded to the flange portion and seal the receiving space,
wherein the flange portion comprises:
a first flange protrusion protruding from a first side of the flange portion, and having a first flange hole; and
a second flange protrusion protruding from a second side opposite to the first side of the flange portion, and having a second flange hole, and
wherein the cover comprises:
a first cover protrusion corresponding to the first flange protrusion, and having a first cover hole; and
a second cover protrusion corresponding to the second flange protrusion, and having a second cover hole.

2. The secondary battery as claimed in claim 1, wherein the case and the cover are configured to be fixed to an external housing by a pair of fastening members, one of the fastening members passing through the first flange hole and the first cover hole, and another of the fastening members passing through the second flange hole and the second cover hole.

3. The secondary battery as claimed in claim 2, wherein an outer surface of the cover is adjacent to an inner surface of the external housing, and contacts the inner surface of the external housing by the fastening members.

4. The secondary battery as claimed in claim 1, further comprising a welding line along the flange portion and bonding the cover to the flange portion, and
wherein the welding line has a closed line shape to seal the receiving space.

5. The secondary battery as claimed in claim 4, wherein the first flange hole, the second flange hole, the first cover hole, and the second cover hole are each spaced from the welding line by a hole separation distance ranging from 5 mm to 7 mm.

6. The secondary battery as claimed in claim 1, wherein the first flange protrusion comprises one or more first flange protrusions along the first side of the flange portion, and the second flange protrusion comprises one or more second flange protrusions along the second side of the flange portion.

7. The secondary battery as claimed in claim 1, wherein the case and the cover comprise the same metallic material as each other.

8. The secondary battery as claimed in claim 7, wherein the metallic material comprises stainless steel.

9. The secondary battery as claimed in claim 1, wherein the first flange hole comprises one or more first flange holes penetrating the first flange protrusion, the second flange hole comprises one or more second flange holes penetrating the second flange protrusion, the first cover hole comprises one or more first cover holes penetrating the first cover protrusion, and the second cover hole comprises one or more second cover holes penetrating the second cover protrusion.

10. The secondary battery as claimed in claim 1, wherein the case comprises an electrode terminal on a side surface of the body portion, the electrode terminal configured to be electrically connected to the electrode assembly.

11. An electrically driven apparatus comprising:
an operation controller;
a housing accommodating the operation controller, and fixing the operation controller in place; and
a secondary battery fixed within the housing, and configured to supply power to the operation controller;
wherein the secondary battery comprises:
a case comprising:
a body portion having a receiving space accommodating an electrode assembly; and
a flange portion extending horizontally from a top of the body portion and surrounding around the receiving space; and
a cover on the top of the body portion to be bonded to the flange portion and seal the receiving space,
wherein the flange portion comprises:
a first flange protrusion protruding from a first side of the flange portion, and having a first flange hole; and
a second flange protrusion protruding from a second side opposite to the first side of the flange portion, and having a second flange hole, and
wherein the cover comprises:
a first cover protrusion corresponding to the first flange protrusion, and having a first cover hole; and
a second cover protrusion corresponding to the second flange protrusion, and having a second cover hole.

12. The electrically driven apparatus as claimed in claim 11, wherein the secondary battery is configured to be fixed to the housing by a pair of fastening members, one of the fastening members passing through the first flange hole and the first cover hole, and another one of the fastening members passing through the second flange hole and the second cover hole.

13. The electrically driven apparatus as claimed in claim 12, wherein an outer surface of the cover is adjacent to an inner surface of the housing, and contacts the inner surface of the housing by the fastening members.

14. The electrically driven apparatus as claimed in claim 11, wherein the case and the cover comprise the same metallic material as each other.

15. The electrically driven apparatus as claimed in claim 14, wherein the metallic material comprises stainless steel.

16. The electrically driven apparatus as claimed in claim 11, wherein the first flange protrusion comprises one or more first flange protrusions along the first side of the flange portion, and the second flange protrusion comprises one or more second flange protrusions along the second side of the flange portion.

17. The electrically driven apparatus as claimed in claim 11, wherein the operation controller comprises one of an application processor (AP) or a central processing unit (CPU) of a portable electronic device, and a motor control unit (MCU) of an electric mobility device.

18. A method for manufacturing a secondary battery, the method comprising:
covering a case with a cover, the case comprising:
a body portion having a receiving space accommodating an electrode assembly; and
a flange portion extending horizontally from a top of the body portion, and surrounding around the receiving space;
bonding the flange portion with the cover to seal the receiving space;
forming a first flange protrusion, a second flange protrusion, a first cover protrusion, and a second cover protrusion by cutting the cover bonded to the flange portion;
forming a first flange hole and a first cover hole penetrating through the first flange protrusion and the first cover protrusion, respectively; and
forming a second flange hole and a second cover hole penetrating through the second flange protrusion and the second cover protrusion, respectively.

19. The method as claimed in claim 18, further comprising fixing the case and the cover to an external housing by a pair of fastening members, one of the fastening members passing through the first flange hole and the first cover hole, and another one of the fastening members passing through the second flange hole and the second cover hole.

20. The method as claimed in claim 18, wherein each of the first flange protrusion and the second flange protrusion comprises one or more flange protrusions along the flange portion, and each of the first cover protrusion and the second cover protrusion comprising one or more cover protrusions along the cover.
